(19) United States
(12) Patent Application Publication
(10) Pub. No.: US 2011/0131397 A1
(43) Pub. Date: Jun. 2, 2011

(54) MULTIPROCESSOR SYSTEM AND MULTIPROCESSOR CONTROL METHOD

(75) Inventor: Kohei AIDA, Kanagawa (JP)

(73) Assignee: NEC Electronics Corporation, Kanagawa (JP)

(21) Appl. No.: 12/956,796

(22) Filed: Nov. 30, 2010

(30) Foreign Application Priority Data
Dec. 1, 2009 (JP) 2009-273335

(51) Int. Cl. G06F 9/38

(52) U.S. Cl. 712/228; 712/E09.045

(57) ABSTRACT

A multiprocessor system includes a memory that stores a program; an address notification register; a first processor; and a second processor, in which the first processor stores address information indicating an address from which the program is executed in the address notification register, when the first processor notifies an interrupt request to the second processor and causes the second processor to execute the program, and the second processor obtains the interrupt request notified from the first processor and the address information stored in the address notification register, and starts to execute the program from the address indicated by the obtained address information.

### INCORPORATION BY REFERENCE

This application is based upon and claims the benefit of priority from Japanese patent application No. 2009-273335, filed on Dec. 1, 2009, the disclosure of which is incorporated herein in its entirety by reference.

### BACKGROUND

1. Field of the Invention

The present invention relates to a multiprocessor system and a multiprocessor control method.

2. Description of Related Art

A multiprocessor system is composed of a plurality of processors connected to each other. The processors need to communicate with each other. Therefore, various inter-processor communication processing techniques have been proposed. Among these techniques, an inter-processor interrupt can asynchronously request a processing to a running processor. Thus, the processing efficiency of the processor is high.

Japanese Unexamined Patent Application Publication No. 06-028320 discloses a multiprocessor system adopting the inter-processor interrupt. In the multiprocessor system disclosed in Japanese Unexamined Patent Application Publication No. 06-028320, each of processors includes interrupt registers respectively corresponding to processors which may send an interrupt request to the own processor. This enables each of the processors to issue the interrupt request to a processor of an interrupt request destination regardless of whether another processor issues the interrupt request to the processor of the interrupt request destination.

### SUMMARY

An exemplary configuration of a multiprocessor system 100 based on the technique disclosed in Japanese Unexamined Patent Application Publication No. 06-028320 is explained with reference to FIG. 9. Note that FIG. 9 is drafted by the inventor, and thus it is not a figure of “prior art”. The multiprocessor system 100 includes processors 110-1 to 110-n, interrupt control units 111-1 to 111-n, interrupt request registers 112-1 to 112-n, a memory 113, a connection medium 114, and an inter-processor interrupt transmission medium 115. Note that n is an arbitrary positive integer. The processor 110-i includes the interrupt request register 112-i. Assume that i indicates any one of 1 to n. Hereafter, an arbitrary processor among the processors 110-1 to 110-n is referred to as “processor 110”. The same holds true for the interrupt control units 111-1 to 111-n and interrupt request registers 112-1 to 112-n.

Each of the processors 110-1 to 110-n notifies an interrupt request to another processor 110 via the inter-processor interrupt transmission medium 115 by writing a value to validate an interrupt into the interrupt request register 112. Note that, in particular, the case where the interrupt source processor which requests the interrupt is the processor 110-1 and the interrupt destination processor to which the interrupt is requested is the processor 110-2 is explained as an example.

When the interrupt source processor 110-1 requests the interrupt to the interrupt destination processor 110-2, the interrupt source processor 110-1 writes the value to validate the interrupt into a register corresponding to the interrupt destination processor 110-2 among registers included in the interrupt request register 112-1. Then, the value is output to the interrupt control unit 111-2 corresponding to the interrupt destination processor 110-2 as the interrupt request via the inter-processor interrupt transmission medium 115. The interrupt control unit 111-2 outputs an interrupt request signal to the interrupt destination processor 110-2 in response to the notification of the interrupt request for the processor 110 corresponding to itself. That is, the interrupt request is notified to the interrupt destination processor 110-2. This causes an inter-processor interrupt from the interrupt source processor 110-1 to the interrupt destination processor 110-2.

However, in the multiprocessor system 100 as described above, when the inter-processor interrupt is performed, only the interrupt request is notified to the interrupt destination processor 110-2 from the interrupt source processor 110-1. Therefore, when information other than the interrupt request has to be notified to the interrupt destination processor 110-2 from the interrupt source processor 110-1, the interrupt source processor 110-1 writes the information into the memory 113. The memory 113 is an area which can be shared and accessed by the interrupt source processor 110-1 and the interrupt destination processor 110-2. This enables the interrupt destination processor 110-2 to obtain the information.

Note that the inter-processor interrupt of the multiprocessor system is used when a processor calls another processor and causes it to execute a program. An outline of a program call processing caused by the inter-processor interrupt of the multiprocessor system 100 is explained with reference to FIG. 10.

Here, the case where the call source processor is the interrupt source processor 110-1 and the call destination processor is the interrupt destination processor 110-2 is explained as an example. The interrupt source processor 110-1 executes a call source program 120. Call destination programs 121-1 to 121-m are programs which may be called from the call source program 120. The number of the call destination programs 121 is m. Assume that m is an arbitrary positive integer.

It is specified which of the call destination programs 121-1 to 121-m is to be called from the call source program 120, based on a parameter decided by an execution result of the call source program 120.

Note that the parameter is a start address from which the call destination program 121 decided to be called as a result of executing the call source program 120 is executed, a name of the program, an ID for specifying the program, or the like. Furthermore, the parameter includes data taken over by the call destination program 121 from the call source program 120 as necessary. Note that, for example, the start address of the call destination program 121 is an arbitrary address such as a starting address of the call destination program 121, or an address of a branch destination processing from a processing of the call source program 120.

Next, a processing of the interrupt source processor 110-1 is explained with reference to FIG. 11. FIG. 11 is a flowchart showing the processing of the interrupt source processor 110-1.

The interrupt source processor 110-1 decides the call destination program 121 executed by the interrupt destination processor 110-2 by executing the call source program 120 (S500). Here, it assumes that the call destination program 121-2 is decided. The interrupt source processor 110-1 writes the parameter for specifying the decided call destination program 121-2 into the memory 113 (S501). Then, the interrupt source processor 110-1 writes a value to validate the interrupt into the register, which corresponds to the interrupt destination processor 110-2 executing the call destination program 121-2, among the registers included in the interrupt request register 112-1 (S502). This notifies the interrupt request to the interrupt destination processor 110-2 from the interrupt source processor 110-1.

Next, a processing of the interrupt destination processor 110-2 is explained with reference to FIG. 12. FIG. 12 is a flowchart showing the processing of the interrupt destination processor 110-2.

The interrupt destination processor 110-2 starts to execute an interrupt handler in response to the interrupt request notified from the interrupt source processor 110-1. After that, the interrupt destination processor 110-2 executes processing of steps S600 to S603 according to an instruction of the interrupt handler.

The interrupt destination processor 110-2 reads the parameter from the memory 113 (S600). The parameter is data for specifying the call destination program 121-2 executed in response to the interrupt request. When the read parameter indicates the name or ID of the call destination program 121-2, the interrupt destination processor 110-2 analyzes the parameter and specifies the call destination program 121-2 (S601). For example, a table in which the name or ID of the program is associated with the start address of the call destination program 121-2 is preliminarily stored in the memory 113. Then, the interrupt destination processor 110-2 specifies the start address of the call destination program 121-2 by referring to the table.

The interrupt destination processor 110-2 calls the call destination program 121-2 specified by the read parameter or the analysis result of the parameter (S602). In particular, the interrupt destination processor 110-2 sets the start address of the call destination program 121-2 specified by the read parameter or the analysis result of the parameter to a program counter. Then, the interrupt destination processor 110-2 loads the call destination program 121 from the memory 113 and executes the call destination program 121 (S603). The interrupt destination processor 110-2 executes the call destination program 121 from the start address set to the program counter.

In this way, in the multiprocessor system 100 based on the technique disclosed in Japanese Unexamined Patent Application Publication No. 06-028320, the interrupt source processor 110-1 can directly notify only the interrupt request to the interrupt destination processor 110-2. Consequently, the interrupt destination processor 110-2 needs to read the parameter from the memory 113, which is shared and accessed by the processors 110-1 to 110-n, so that the interrupt destination processor 110-2 can execute the call destination program 121 in response to the interrupt request.

However, generally, the access from the processors 110-1 to 110-n to the memory 113 is exclusively controlled. The exclusive access control prevents the processors 110-1 to 110-n from accessing at the same time, thereby maintaining data consistency. Consequently, in the case where another processor 110 accesses the memory 113 when the interrupt destination processor 110-2 accesses the memory 113 to read the parameter, the access of the interrupt destination processor 110-2 is kept waiting. This causes a problem that performance of the inter-processor interrupt processing deteriorates.

A first exemplary aspect of the present invention is a multiprocessor system including: a memory that stores a program; an address notification register; a first processor; and a second processor, in which the first processor stores address information indicating an address from which the program is executed in the address notification register, when the first processor notifies an interrupt request to the second processor and causes the second processor to execute the program, and the second processor obtains the interrupt request notified from the first processor and the address information stored in the address notification register, and starts to execute the program from the address indicated by the obtained address information.

A second exemplary aspect of the present invention is a multiprocessor system including: a memory that stores a program; an address notification register; a first processor; and a second processor, in which the first processor stores address information indicating an address from which the program is executed in the address notification register, when the first processor causes the second processor to execute the program, and the second processor determines that an interrupt request is notified from the first processor when the address information is stored in the address notification register, and starts to execute the program from the address indicated by the address information.

A third exemplary aspect of the present invention is a multiprocessor control method including: storing, by a first processor, an address information indicating an address from which an program is executed in an address notification register, when the first processor notifies an interrupt request to a second processor and causes the second processor to execute the program; obtaining, by the second processor, the interrupt request notified from the first processor and the address information stored in the address notification register; and starting, by the second processor, to execute the program from the address indicated by the obtained address information.

A fourth exemplary aspect of the present invention is a multiprocessor control method including: storing, by a first processor, address information indicating an address from which an program is executed in an address notification register, when the first processor causes a second processor to execute the program; determining, by the second processor, that an interrupt request is notified from the first processor when the address information is stored in the address notification register; and starting, by the second processor, to execute the program from the address indicated by the address information.

According to exemplary aspects of the present invention, there is no need for the second processor, which is the interrupt destination processor, to obtain the start address from which the program is executed, from the memory shared by the processors. Therefore, there is no need to wait to obtain the start address. Consequently, it is possible to improve performance of the inter-processor interrupt processing.

According to exemplary aspects of the present invention, it is possible to provide a multiprocessor system and a multiprocessor control method that are capable of improving performance of an inter-processor interrupt processing.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a configuration diagram of a multiprocessor system in accordance with a first exemplary embodiment of the present invention;

FIG. 2 is a diagram showing a relationship of an interrupt request register, interrupt control units, and processors in accordance with a first exemplary embodiment of the present invention;

FIG. 3 is a diagram showing relationships among address notification registers, selectors, and processors in accordance with the first exemplary embodiment of the present invention;

FIG. 4 is a flowchart showing processing of an interrupt source processor 10 in accordance with the first exemplary embodiment of the present invention;

FIG. 5 is a flowchart showing processing of an interrupt destination processor in accordance with the first exemplary embodiment of the present invention;

FIG. 6 is a configuration diagram of a multiprocessor system in accordance with a second exemplary embodiment of the present invention;

FIG. 7 is a diagram showing relationships among an interrupt request address notification registers, interrupt control units, selectors, and processors in accordance with the second exemplary embodiment of the present invention;

FIG. 8 a flowchart showing processing of an interrupt source processor in accordance with the second exemplary embodiment of the present invention;

FIG. 9 is a configuration diagram of a multiprocessor system;

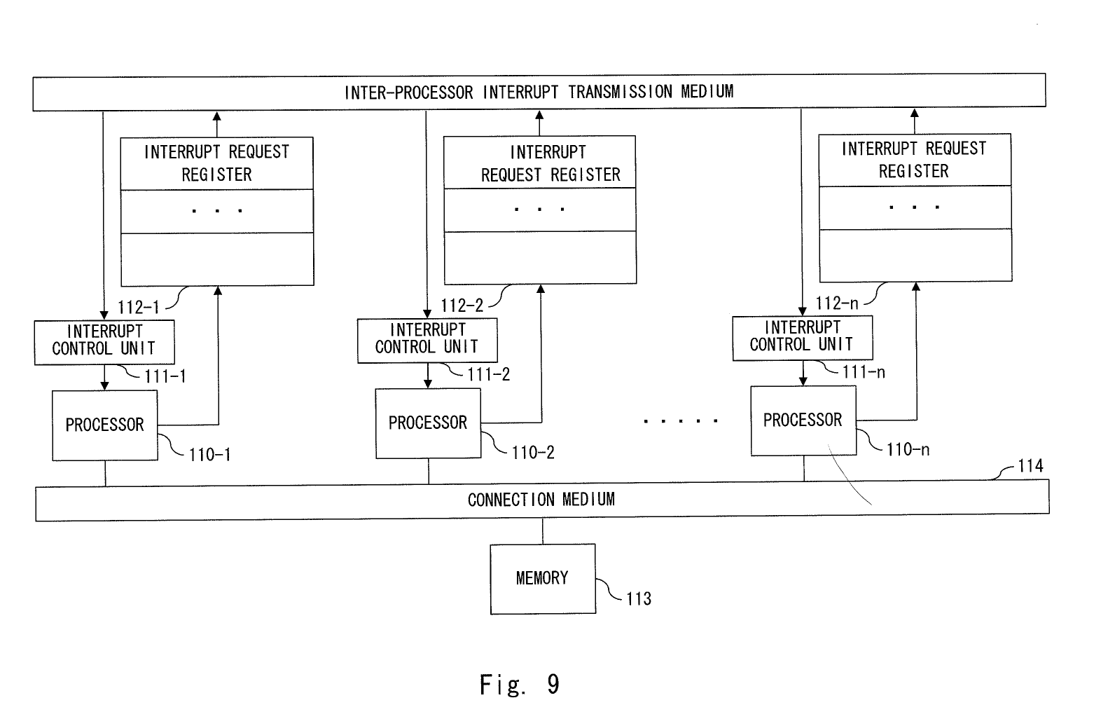

FIG. 10 is a diagram showing an outline of a program call processing caused by an inter-processor interrupt;

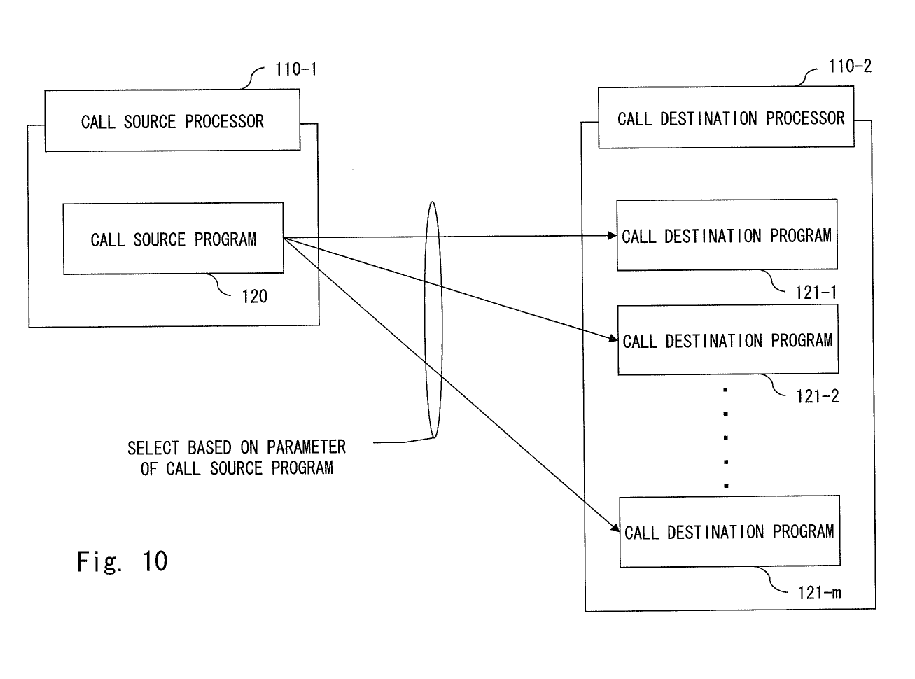

FIG. 11 is a flowchart showing the processing of an interrupt source processor; and

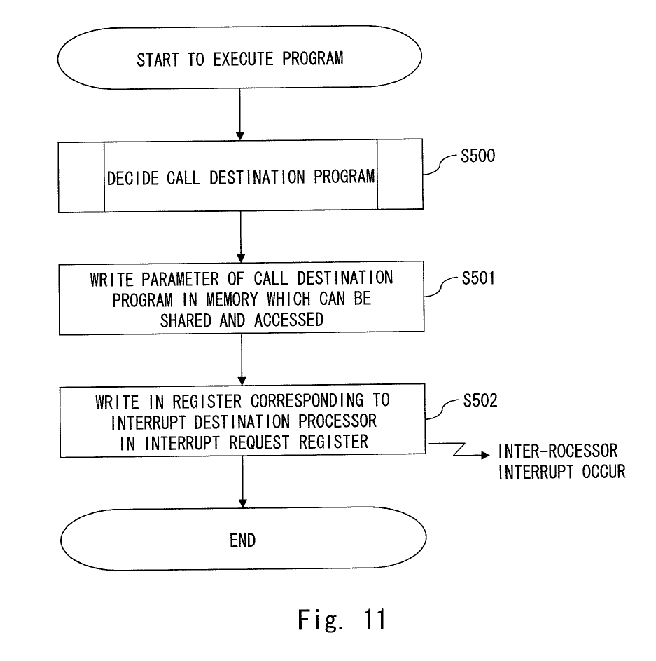

FIG. 12 is a flowchart showing the processing of an interrupt destination processor.

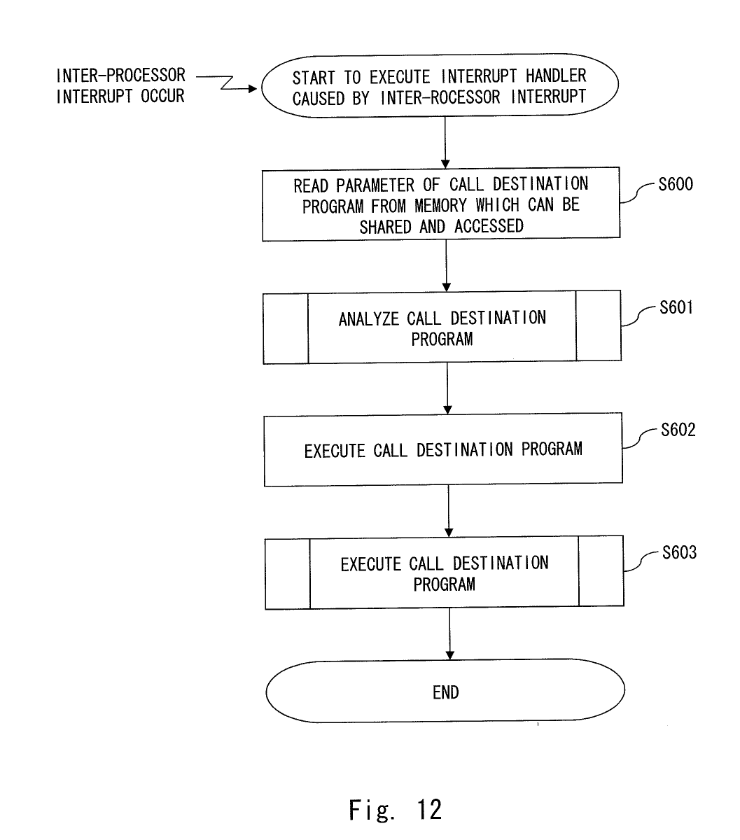

### DETAILED DESCRIPTION OF THE EXEMPLARY EMBODIMENTS

### First Exemplary Embodiment

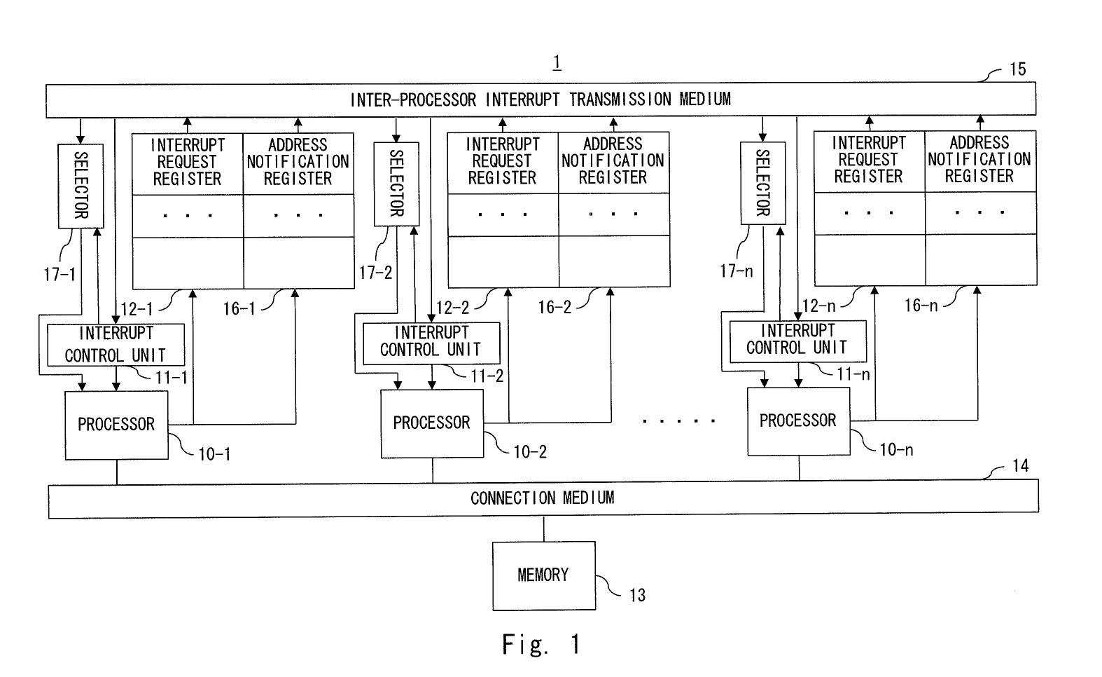

A configuration of a multiprocessor system 1 in accordance with a first exemplary embodiment of the present invention is explained with reference to FIG. 1. FIG. 1 is a diagram showing the configuration of the multiprocessor system 1 in accordance with the first exemplary embodiment of the present invention.

The multiprocessor system 1 includes processors 10-1 to 10-n, interrupt control units 11-1 to 11-n, interrupt request registers 12-1 to 12-n, a memory 13, a connection medium 14, an inter-processor interrupt transmission medium 15, address notification registers 16-1 to 16-n, and selectors 17-1 to 17-n. Note that n is an arbitrary positive integer. The processor 10-i includes the interrupt request register 12-i and the address notification register 16-i. Assume that i indicates any one of 1 to n. Hereinafter, an arbitrary processor among the processors 10-1 to 10-n is referred to as “processor 10”. The same holds true for the interrupt control units 11-1 to 11-n, interrupt request registers 12-1 to 12-n, address notification registers 16-1 to 16-n, and selectors 17-1 to 17-n.

Each of the processors 10-1 to 10-n executes a program (not shown) stored in the memory 13. Each of the processors 10-1 to 10-n causes another processor 10 to execute a call destination program according to an execution result of a call source program. In that case, each of the processors 10-1 to 10-n notifies an interrupt request to another processor 10. The processor 10 notifying the interrupt request stores a start address of the call destination program executed by another processor 10 in the address notification register 16.

Each of the processors 10-1 to 10-n is notified of the interrupt request from another processor 10. Each of the processors 10-1 to 10-n starts to execute the call destination program in response to the notification of the interrupt request. In that case, the processor 10 which has been notified of the interrupt request obtains the start address stored in the address notification register 16, and starts to execute the call destination program from the obtained start address.

Each of the interrupt control units 11-1 to 11-n is notified of the interrupt request for the processor 10 corresponding to itself. Each of the interrupt control units 11-1 to 11-n notifies the interrupt request to the processor 10 in response to the notification of the interrupt request. That is, the interrupt request from the processer 10 to another processer 10 is notified via the interrupt control unit 11. When the interrupt control unit 11 is notified of the interrupt request from a plurality of processors 10, the interrupt control unit 11 decides which of the interrupt requests from the processors 10 is notified to the processor 10 corresponding to itself. Then, when the decided interrupt request is notified, the interrupt control unit 11 outputs to the selector 17 a signal for selecting the start address to be output to the processor 10 among start addresses stored in the address notification registers 16-1-16-n. Note that the interrupt request notified to the processor 10 may be decided in any way. For example, it is decided according to a priority order which is arbitrarily determined.

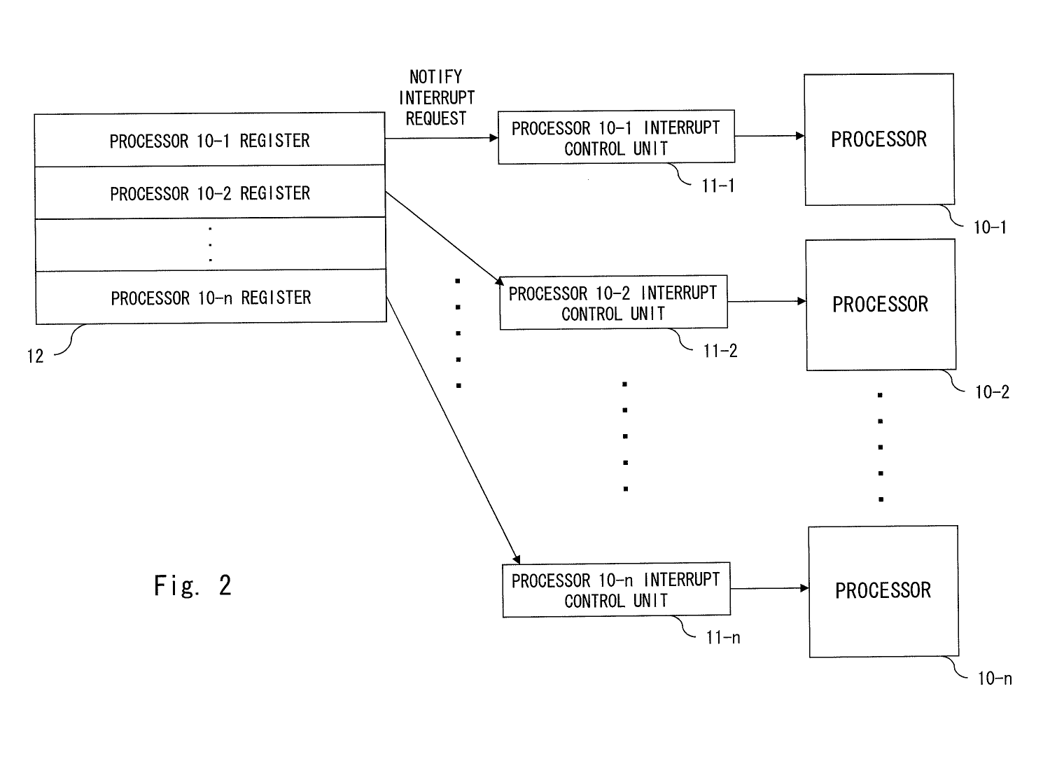

Each of the interrupt request registers 12-1 to 12-n stores values indicating whether the interrupt request is validated for each of the processors 10-1 to 10-n. Each of the interrupt request registers 12-1 to 12-n includes a plurality of registers respectively corresponding to the processors 10-1 to 10-n as illustrated in FIG. 2. When the value to validate the interrupt request is written into the register corresponding to the interrupt destination processor 10, the value is output to the interrupt control unit 11 corresponding to the interrupt destination processor 10 as an interrupt request via the inter-processor interrupt transmission medium 15.

The memory 13 stores one or more program(s) including the call destination program and the call source program. Note that the call destination program and the call source program may be included in a same program. The memory 13 stores configuration information indicating how the program is located. The connection medium 14 transmits any data between the processors 10-1 to 10-n and the memory 13. The connection medium 14 is, for example, a bus.

The inter-processor interrupt transmission medium 15 outputs the values of the interrupt request registers 12-1 to 12-n of the processors 10-1 to 10-n to the interrupt control units 11-1 to 11-n, respectively. For example, the inter-processor interrupt transmission medium 15 may output at least the values of the registers corresponding to the processor 10-j among the values of the registers included in the interrupt control registers 12-1 to 12-n to the interrupt control unit 11-j. Assume that j indicates any one of 1 to n.

The inter-processor interrupt transmission medium 15 outputs the values of the address notification registers 16-1 to 16-n of the processors 10-1 to 10-n to the selectors 17-1 to 17-n, respectively. For example, the inter-processor interrupt transmission medium 15 may output at least the values of the registers corresponding to the processor 10-j among the values of the registers included in each of the address notification registers 16-1 to 16-n to the selector 17-j. For example, the inter-processor interrupt transmission medium 15 is a bus.

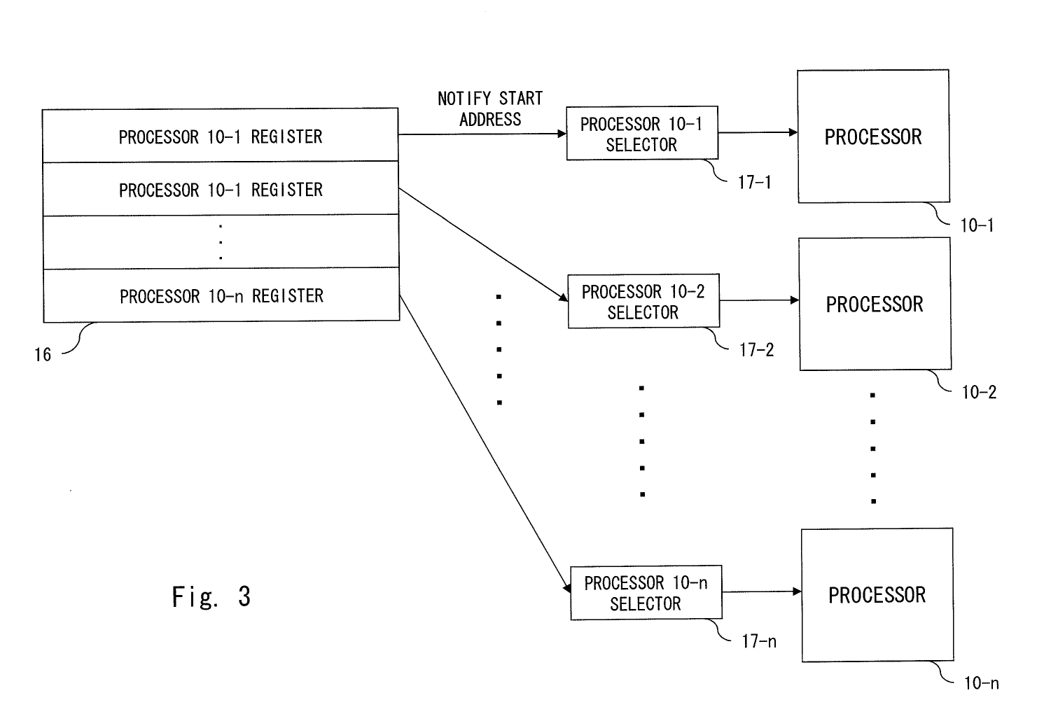

Each of the address notification registers 16-1 to 16-n stores the start address from which the program is executed by the interrupt destination processor 10. As illustrated in FIG. 3, each of the address request registers 16-1 to 16-n includes a plurality of registers respectively corresponding to the processors 10-n to 10-n. Specifically, the registers included in the address notification register 16-j respectively correspond to the registers included in the interrupt request register 12-j.

Each of the selectors 17-1 to 17-n outputs the value of the register selected by the interrupt control unit 11 from among the values, which are input via the inter-processor interrupt transmission medium 15, of the registers of the address notification registers 17-1 to 17-n to the processor 10 corresponding to itself.

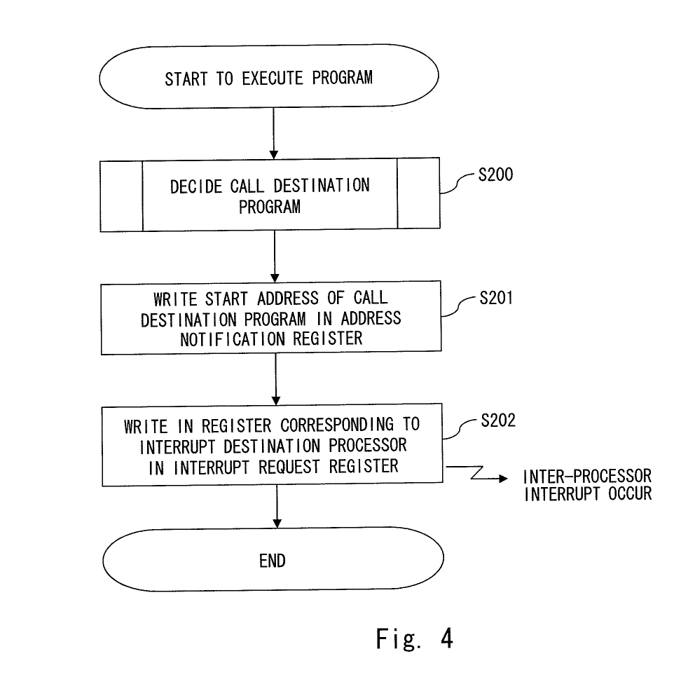

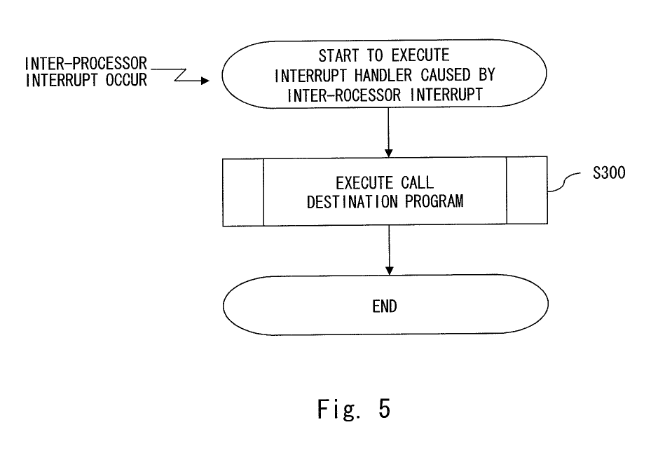

Next, a processing of the multiprocessor system 1 in accordance with the first exemplary embodiment of the present invention is explained with reference to FIGS. 4 and 5. First, a processing of the interrupt source processor 10 in accordance with the first exemplary embodiment of the present invention is explained with reference to FIG. 4. FIG. 4 is a flowchart showing the processing of the interrupt source processor 10 in accordance with the first exemplary embodiment of the present invention. Here, the case where the interrupt source processor is the processor 10-1 and the interrupt destination processor is the processor 10-2 is explained as an example.

The interrupt source processor 10-1 executes the call source program stored in the memory 13. The interrupt source processor 10-1 decides the call destination program to be executed by another processor 10, based on an execution result of the call source program (S200). In this case, the interrupt source processor 10-1 decides the interrupt destination processor 10-2 to be caused to execute the call destination program. Note that the interrupt destination processor 10 may be decided in any way among the processors 10-2 to 10-n. For example, the interrupt destination processor 10 is decided according to a priority order which is arbitrarily determined.

The interrupt source processor 10-1 writes the start address, which is decided by the execution of the call source program, into the register corresponding to the processor 10-2 decided as the interrupt destination among the registers included in the address notification register 16-1 corresponding to itself (S201). The start address written in the register is output to the selector 17-2 corresponding to the interrupt destination processor 10-2 via the inter-processor interrupt transmission medium 15.

Note that, if the name or ID of the call destination program is decided, the interrupt source processor 10-1 specifies the start address by referring to a table in which the name or ID of the program is associated with the start address. The interrupt source processor 10-1 writes the specified start address in the address notification register 16-1. For example, this table is stored into the memory 13.

After writing the start address, the interrupt source processor 10-1 writes the value to validate the interrupt in the register corresponding to the processor 10-2 decided as the interrupt destination among the registers included in the interrupt request register 12-1 corresponding to itself (S202). The value written in the register is output to the interrupt control unit 11-2 corresponding to the interrupt destination processor 10-2 as the interrupt request via the inter-processor interrupt transmission medium 15. That is, the interrupt request for the interrupt destination processor 10-2 is output to the interrupt control unit 11-2.

In this way, the value of the register corresponding to the processor 10-2 among the registers included in the interrupt request register 12-1 becomes the value to validate the interrupt request. Therefore, the interrupt control unit 11-2 determines that the interrupt request for the processor 10-2 corresponding to itself is notified. The interrupt control unit 11-2 decides the interrupt request to be notified to the processor 10-2 among the interrupt requests notified to the processor 10-2. In this example, the interrupt request is notified only from the processor 10-1. Therefore, the interrupt control unit 11-2 decides to notify the interrupt request from the processor 10-1 the processor 10-2.

Thus, the processor 10-2 outputs to the selector 17-2 the signal for selecting the value of the register corresponding to the processor 10-2 among the values of the registers included in the address notification register 16-1 corresponding to the processor 10-1 as the value of the register to be output to the processor 10-2.

The selector 17-2 outputs to the processor 10-2 the value of the register selected by the signal output from the interrupt control unit 11-2 among the values of the registers of the address notification registers 16-1 to 16-n input via the inter-processor interrupt transmission medium 15. This outputs the start address stored in the selected register to the interrupt destination processor 10-2. That is, the start address written by the interrupt source processor 10-1 is notified to the interrupt destination processor 10-2.

Then, the interrupt control unit 11-2 outputs the interrupt request signal to the interrupt destination processor 10-2. That is, the interrupt request is notified to the interrupt destination processor 10-2. This causes the inter-processor interrupt from the interrupt source processor 10-1 to the interrupt destination processor 10-2.

Next, a processing of the interrupt destination processor 10 in accordance with the first exemplary embodiment of the present invention is explained with reference to FIG. 5. FIG. 5 is a flowchart showing the processing of the interrupt destination processor 10 in accordance with the first exemplary embodiment of the present invention.

The interrupt destination processor 10-2 determines that the interrupt request is notified to itself, when the interrupt request signal is output from the interrupt control unit 11-2. In response, the interrupt destination processor 10-2 obtains the start address output from the selector 17-2, and sets the obtained start address to a program counter. Then, the interrupt destination processor 10-2 loads the call destination program from the memory 13, and executes the call destination program from the start address set to the program counter (S300). That is, the interrupt destination processor 10-2 starts to execute the program by using the start address output from the selector 17-2 as an interrupt handler address.

As described above, in this first exemplary embodiment, when the interrupt source processor notifies the interrupt request to the interrupt destination processor and causes the interrupt destination processor to execute the program, the interrupt source processor stores the start address in the address notification register. Then, the interrupt destination processor starts to execute the program from the start address stored in the address notification register. This eliminates the need for the interrupt destination processor to obtain the start address from the memory shared by a plurality of processors. Therefore, there is no need to wait to obtain the start address. Consequently, it is possible to improve performance of the inter-processor interrupt processing. Furthermore, the interrupt destination processor can obtain the start address via the register the access speed of which is faster than that of the memory. Therefore, it is possible to further improve performance of the inter-processor interrupt processing.

Furthermore, in this first exemplary embodiment, the interrupt destination processor obtains the start address stored in the address notification register, and sets the obtained start address to the program counter as the interrupt handler address. Therefore, the call destination program can be immediately executed as the interrupt handler. This eliminates the need for the interrupt destination processor to execute the call destination program after executing a call processing of the call destination program in the interrupt handler executed in response to the interrupt request. Note that the call processing of the call destination processing is a processing in which the start address of the call destination program is set to the program counter. Therefore, it is possible to improve performance of the inter-processor interrupt processing.

### Second Exemplary Embodiment

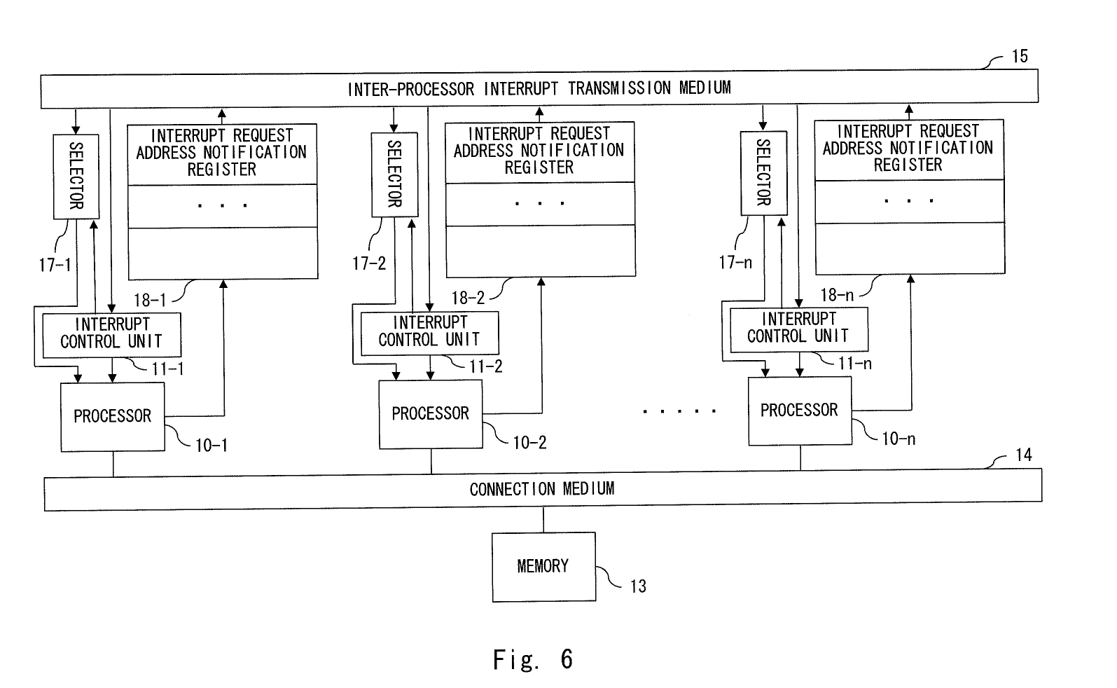

A configuration of a multiprocessor system 2 in accordance with a second exemplary embodiment of the present invention is explained with reference to FIG. 6. FIG. 6 is a diagram showing the configuration of the multiprocessor system 2 in accordance with the second exemplary embodiment of the present invention. Note that the description of the constituent elements similar to those of the first exemplary embodiment is omitted.

The multiprocessor system 2 includes interrupt request address notification registers 18-1 to 18-n in place of the interrupt registers 12-1 to 12-n and the address notification registers 16-1 to 16-n. The processor 10-i includes the interrupt request address notification register 18-i. Hereinafter, an arbitrary interrupt request address notification register among the interrupt request address notification registers 18-1 to 18-n is referred to as “interrupt request address notification register 18”.

Each of the interrupt request address notification registers 18-1 to 18-n stores the start address from which the program is executed by the interrupt destination processor 10. Each of the interrupt request address notification registers 18-1 to 18-n is also used as a register storing the values indicating whether the interrupt request is validated for each of the processors 10-1 to 10-n. That is, the start address stored in the interrupt request address notification register 18 is used as the value to validate the interrupt request for the processers 10.

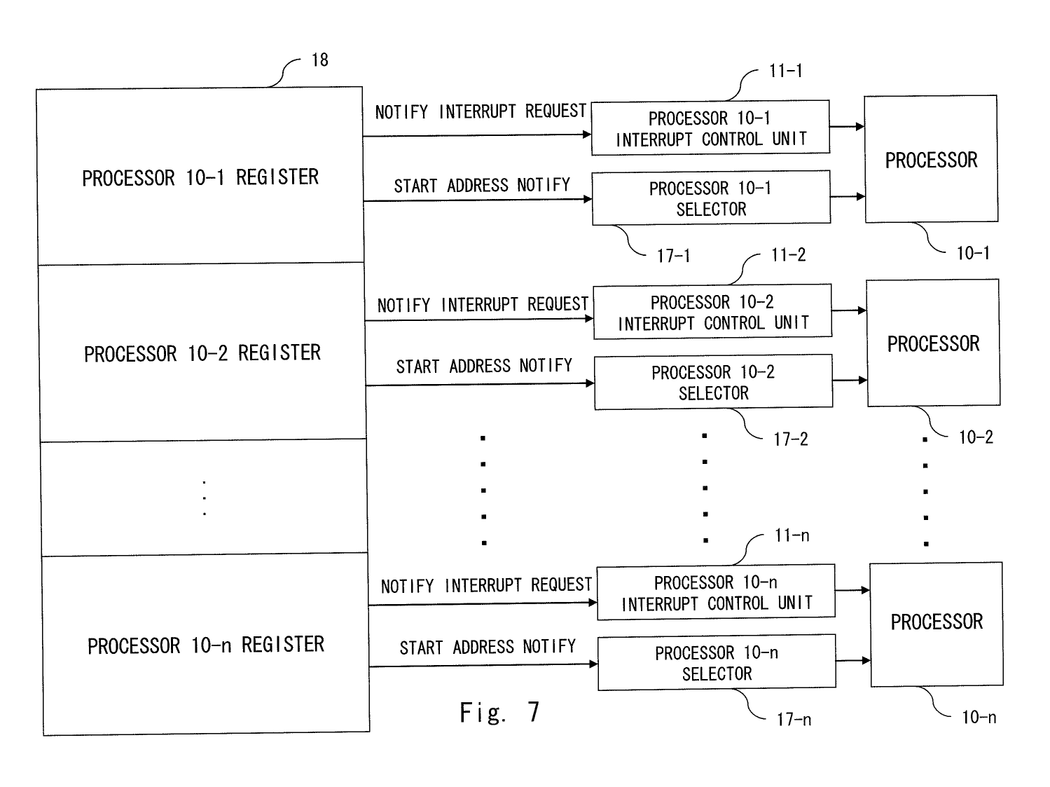

As illustrated in FIG. 7, each of the interrupt request address notification registers 18-1 to 18-n includes a plurality of registers respectively corresponding to the processors 10-1 to 10-n. When the start address is written into the register corresponding to the interrupt destination processor 10, the start address is output to the interrupt control unit 11 corresponding to the interrupt destination processor 10 as the interrupt request via the inter-processor interrupt transmission medium 15. That is, when the interrupt request is not validated, the interrupt request address notification register 18 stores a predetermined value, which is not used as the start address, such as all “0” or all “1”, for example.

The inter-processor interrupt transmission medium 15 differs from that of the first exemplary embodiment in the following point. That is, the inter-processor interrupt transmission medium 15 outputs the values of the interrupt request address notification registers 18-1 to 18-n of the processors 10-1 to 10-n to the interrupt control units 11-1 to 11-n and the selectors 17-1 to 17-n, respectively. For example, the inter-processor interrupt transmission medium 15 may output at least the values of the registers corresponding to the processor 10-j among the values of the registers included in each of the interrupt request address notification registers 18-1 to 18-n to the interrupt control unit 11-j and the selector 17-j.

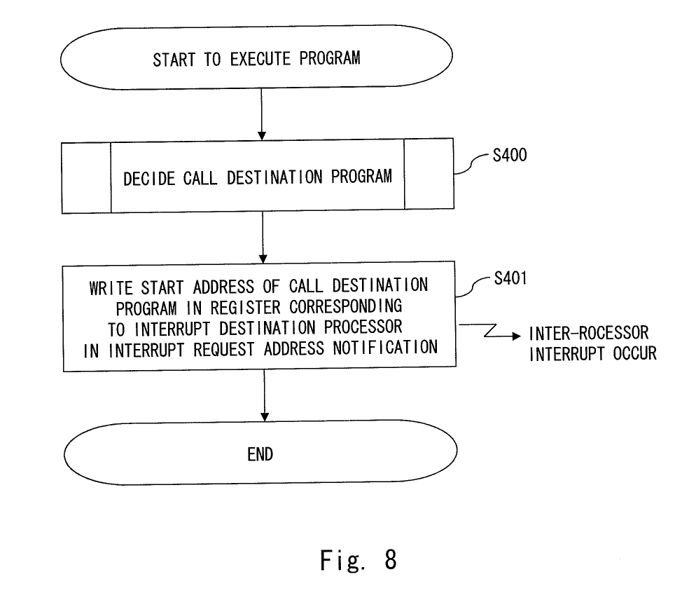

Next, a processing of the multiprocessor system 2 in accordance with the second exemplary embodiment of the present invention is explained with reference to FIG. 8. Note that the description of processing similar to that of the first exemplary embodiment is omitted. The processing of the interrupt source processor 10 in accordance with the second exemplary embodiment of the present invention is explained with reference to FIG. 8. FIG. 8 is a flowchart showing the processing of the interrupt source processor 10 in accordance with the second exemplary embodiment of the present invention. Here, the case where the interrupt source processor is the processor 10-1 and the interrupt destination processor is the processor 10-2 is explained as an example in the same way as the first exemplary embodiment.

The description of the processing of step S400 is omitted, since it is similar to step S200 in accordance with the first exemplary embodiment of the present invention. The interrupt source processor 10-1 writes the start address decided by the execution of the call source program into the register corresponding to the processor 10-2 decided as the interrupt destination among the registers included in the interrupt request address notification register 18-1 corresponding to itself (S401). The start address written in the register is output to the interrupt control unit 11-2 and the selector 17-2 corresponding to the interrupt destination processor 10-2 via the inter-processor interrupt transmission medium 15.

In this second exemplary embodiment, the start address stored in each of the interrupt request address notification registers 18 is also used as the value to validate the interrupt request. Therefore, the interrupt request for the interrupt destination processor 10-2 is output to the interrupt control unit 11-2. Consequently, the interrupt control unit 11-2 determines that the interrupt request for the processor 10-2 corresponding to itself is notified. Details of the subsequent processing are similar to those of the first exemplary embodiment, so the description thereof is omitted. Furthermore, the processing details of the interrupt destination processor 10-2 are also similar to those of the first exemplary embodiment, so the description thereof is omitted.

As described above, in this second exemplary embodiment, when the interrupt source processor notifies the interrupt request to the interrupt destination processor and causes the interrupt destination processor to execute the program, the interrupt source processor stores the start address in the address notification register, in the same manner as in the first exemplary embodiment. Then, the interrupt destination processor starts to execute the program from the start address stored in the interrupt request address notification register. This eliminates the need for the interrupt destination processor to obtain the start address from the memory shared by a plurality of processors. Therefore, there is no need to wait to obtain the start address. Consequently, it is possible to improve performance of the inter-processor interrupt processing. Furthermore, the interrupt destination processor can obtain the start address via the register the access speed of which is faster than that of the memory. Therefore, it is possible to further improve performance of the inter-processor interrupt processing.

Furthermore, unlike the first exemplary embodiment, this second exemplary embodiment allows the interrupt request and the start address to be notified by the interrupt request address notification register. Therefore, it is possible to reduce the number of the registers corresponding to the interrupt request registers. This enables to reduce the cost by an amount corresponding to the reduced registers.

The present invention is not limited to the above exemplary embodiments, but can be modified as appropriate within the scope of the present invention. For example, the multiprocessor system may not include the interrupt control units and the selectors, and the values of the registers may be directly input to each processor. However, the multiprocessor system may be preferably configured such that only the interrupt request signal is output to the processor from the interrupt control unit and only the start address selected by the interrupt control unit is notified to the processor from the selector. In doing so, the number of signal lines and the number of input terminals of the processor can be reduced.

The multiprocessor system in accordance with an exemplary embodiment of the present invention can also be configured by causing a compute or a processor, which is used as the interrupt source processor or the interrupt destination processor and is included in the computer, to execute the program for implementing the functions according to the above exemplary embodiments.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the functions according to the above exemplary embodiments can be implemented by causing a computer to execute the program for implementing the functions according to the exemplary embodiments, the functions according to the exemplary embodiments can also be implemented in the following case. That is, the functions according to the exemplary embodiments can be implemented in cooperation with an operating system (OS) or application software running on a computer, in response to an instruction from the program.

Moreover, the functions according to the exemplary embodiments can also be implemented when all or part of the processing for the program is executed by a function extension board inserted into a computer or a function extension unit connected to a computer.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A multiprocessor system comprising:
a memory that stores a program;
at least one address notification register;
at least one first processor; and
at least one second processor, wherein
the first processor stores address information indicating an address from which the program is executed in the address notification register, when the first processor notifies an interrupt request to the second processor and causes the second processor to execute the program, and
the second processor obtains the interrupt request notified from the first processor and the address information stored in the address notification register, and starts to execute the program from the address indicated by the obtained address information.

2. The multiprocessor system according to claim 1, wherein
the at least one first processor comprises a plurality of first processors, and
the at least one address notification register comprises address notification registers respectively corresponding to the first processors.

3. The multiprocessor system according to claim 1, wherein
the at least one second processor comprises a plurality of second processors,
the address information stored in the address notification register includes a plurality of pieces of address information respectively corresponding to the second processors, and
the second processor obtains the address information corresponding to itself.

4. The multiprocessor system according to claim 3, further comprising a select unit that selectively outputs to the second processor the address information corresponding to the second processor notified of the interrupt request.

5. The multiprocessor system according to claim 1, wherein the second processor starts to execute the program from the address indicated by the address information stored in the address notification register by using the address as an interrupt handler address in response to the notification of the interrupt request.

6. The multiprocessor system according to claim 1, wherein
the first processor also operates as the second processor, and
the second processor also operates as the first processor.

7. A multiprocessor system comprising:
a memory that stores a program;
at least one address notification register;
at least one first processor; and
at least one second processor, wherein
the first processor stores address information indicating an address from which the program is executed in the address notification register, when the first processor causes the second processor to execute the program, and
the second processor determines that an interrupt request is notified from the first processor when the address information is stored in the address notification register, and starts to execute the program from the address indicated by the address information.

8. The multiprocessor system according to claim 7, wherein
the at least one first processor comprises a plurality of first processors, and
the at least one address notification register comprises a plurality of address notification registers respectively corresponding to the first processors.

9. The multiprocessor system according to claim 7, wherein
the at least one second processor comprises a plurality of second processors,
the address notification register includes a plurality of pieces of address information respectively corresponding to the second processors, and
the second processor obtains the address information corresponding to itself.

10. The multiprocessor system according to claim 9, further comprising a select unit that selectively outputs the address information corresponding to the second processor notified of the interrupt request to the second processor.

11. The multiprocessor system according to claim 7, wherein the second processor starts to execute the program from the address indicated by the address information stored in the address notification register by using the address as an interrupt handler address in response to the notification of the interrupt request.

12. The multiprocessor system according to claim 7, wherein
the first processor also operates as the second processor, and
the second processor also operates as the first processor.

13. A multiprocessor control method comprising:
storing, by a first processor, an address information indicating an address from which a program is executed in an address notification register, when the first processor notifies an interrupt request to a second processor and causes the second processor to execute the program;
obtaining, by the second processor, the interrupt request notified from the first processor and the address information stored in the address notification register; and
starting, by the second processor, to execute the program from the address indicated by the obtained address information.

14. A multiprocessor control method comprising:
storing, by a first processor, an address information indicating an address from which a program is executed in an address notification register, when the first processor causes a second processor to execute the program;
determining, by the second processor, that an interrupt request is notified from the first processor when the address information is stored in the address notification register; and
starting, by the second processor, to execute the program from the address indicated by the address information.
